(19) United States
(12) Patent Application Publication
(10) Pub. No.: US 2014/0226582 A1
(43) Pub. Date: Aug. 14, 2014

(54) Method and Apparatus for Providing Channel State Information (CSI) Measurement and Reporting for a Segment Carrier

(71) Applicants: Erlin Zeng, Beijing (CN); Chunyan Gao, Beijing (CN); Na Wei, Beijing (CN); Gilles Charbit, Farnborough (GB); Haiming Wang, Beijing (CN); Wei Bai, Beijing (CN); Wei Hong, Beijing (CN); Jing Han, Beijing (CN); Shuang Tan, Beijing (CN); Tommi Koivisto, Espoo (FI)

(72) Inventors: Erlin Zeng, Beijing (CN); Chunyan Gao, Beijing (CN); Na Wei, Beijing (CN); Gilles Charbit, Farnborough (GB); Haiming Wang, Beijing (CN); Wei Bai, Beijing (CN); Wei Hong, Beijing (CN); Jing Han, Beijing (CN); Shuang Tan, Beijing (CN); Tommi Koivisto, Espoo (FI)

(21) Appl. No.: 14/234,053

(22) PCT Filed: Jul. 19, 2011
(86) PCT No.: PCT/CN2011/077331

§ 371 Date: Mar. 18, 2014

(51) Int. Cl. H04W 24/10; H04L 5/00

(52) U.S. Cl. CPC H04W 24/10; H04L 5/0057
USPC 370/329; 370/328

(57) ABSTRACT

Methods, apparatus and computer program products provide channel state information (CS1) measurement and reporting for a segment carrier in certain situations. An apparatus such as a base station may determine whether CSI is needed for a channel of a segment carrier comprising a segment portion and a contiguous bandwidth extension of a backward compatible carrier utilized by a base station for wireless communications with a mobile terminal. In response to determining that CSI is needed, the apparatus configures the mobile terminal to communicate channel state information from the mobile terminal to the base station. In other embodiments, an apparatus such as a mobile terminal is configured to receive configuration data indicating whether CSI is to be measured by the mobile terminal, and measuring the CSI and communicating the CSI to the base station in response to the configuration data.

### TECHNOLOGICAL FIELD

Embodiments of the present invention relate generally to communications technology and, more particularly, to methods and apparatus for providing channel state information (CSI) measurement and reporting for a segment carrier.

### BACKGROUND

In wireless communications, the Long-Term Evolution (LTE) specification provides for multiple-input multiple output (“MIMO”) transmission modes that provide a high performance mobile terminal experience with elevated throughput levels, increased coverage, and enhanced spectral efficiency. To provide this enhanced mobile experience according to the LTE specification, data is encoded, modulated, and mapped to a certain number of layers of the communication channel between a base station and mobile terminal. These certain number of layers are then encoded and mapped to one or more antenna ports via a procedure that is configured to use one of several transmission modes. The number of the certain number of layers is referred to as the “transmission rank”.

Channel state information (“CSI”) is utilized in such MIMO communications to estimate the quality of the communication channel. As such, this CSI information may include any information which can describe the quality or characteristics of a communication channel, including a channel quality indicator (“CQI”) and a precoding matrix indicator (“PMI”) which are both helpful to the base station, e.g., evolved node B (“eNB”), when scheduling the physical downlink shared control channel (“PDSCH”). The PDSCH channel carries user data, broadcast system information, and paging messages. Thus, with underlying CSI information, a transmitter can achieve a higher channel capacity compared to a transmitter operating without CSI information as the transmitter can perform any configuration necessary before transmission to accommodate the communication channel.

In 3GPP LTE/LTE-Advanced, a new carrier type has been proposed that includes a segment carrier, which may comprise contiguous bandwidth extension of a backwards compatible component carrier. Because this new segment carrier includes a backwards compatible component carrier, this new segment carrier can accommodate cutting-edge LTE mobile terminals as well as legacy terminals, on the same carrier. However, this segment carrier has significantly larger carrier bandwidth than carriers in previous releases of LTE to provide such backwards compatibility. This segment carrier also has a single physical downlink control channel (PDCCH), a single hybrid automatic repeat request (HARQ) for combined bandwidth, and a contiguous bandwidth requirement with a maximum bandwidth requirement of 110 resource blocks. Another segment carrier has also been introduced in 3GPP LTE/LTE-Advanced, called an extension carrier, which may not necessarily have contiguous bandwidth to a backward compatible carrier.

The segment carrier which has been introduced in the latest versions of LTE Advanced proves very complicated when considering how, and when, to measure or estimate CSI information. While CSI measurement and reporting has been discussed in Releases 8, 9, and 10 of LTE, the determination of when and how to perform such CSI measurement and reporting for the segment carrier remains unanswered. One such complication arises because of the nature of the segment carrier having a backwards compatible portion for legacy terminals, which comprises the 3GPP RAN1 layer, and therefore, the segment carrier does not include any cell-specific reference (CRS) signals. CRS signals, much like the name, are signals that are specific to a particular cell in a telecommunications network. Because CRS signals are integral to CSI measurement and reporting, it is unknown how to obtain CSI information in the absence of CRS signals in the LTE segment carrier. Therefore, because the segment carrier includes the RAN1 layer, the segment carrier may be measuring and reporting CSI based on CRS signals in the backward compatible carrier, and will have to rely on CSI-RS in the segment carrier.

Various transmission modes also present a complication regarding CSI measurement and reporting. There are nine transmission modes described in the LTE specification, with transmission modes 1-7 in Release 8, transmission mode 8 in Release 9, and transmission mode 9 in Release 10. Transmission modes 1 and 7 are identical from the perspective of the mobile terminal, and involve a single transmission layer. However, in transmission mode 1, the layer is transmitted from one antenna port, and in transmission mode 7, the layer is transmitted from a combination of antenna ports. Transmission mode 2 involves transmission of a single layer encoded with a space-frequency block code (SFBC) on the Alamouti code and transmitted from a combination of antennae.

Transmission mode 3, when the rank is 1, is identical to transmission mode 1. When the rank is greater than 1, a predefined codebook of preorder matrices is cycled across the frequency band along with a layer permutation to give each layer a similar average channel quality. Transmission mode 4 is a closed-loop spatial multiplexing mode, and involves one or more layers being transmitted using a pre-coder matrix which is selected based on channel measurements made by the mobile terminal. Transmission mode 5 is the multi-user MIMO transmission mode, and involves a single layer transmission to several users who simultaneously share the same frequency allocation. Transmission mode 6 is similar to transmission mode 4 but is restricted to rank 1 transmissions. Transmission mode 8 provides single or dual layer transmission with mobile terminal specific radio signals. LTE-Advanced also adds transmission mode 9, which is a multi-layer transmission mode that supports closed loop SU-MIMO up to rank 8.

In transmission modes 1-8, CSI measurement and reporting are based on CRS signals. For transmission mode 9, CSI measurement and reporting is based on CSI-RS signals. Only new mobile terminals, such as mobile terminals in compliance with Release 11 or beyond, which support transmission mode 9 can be scheduled on the segment portion of the segment carrier. However, it is possible that these new mobile terminals may utilize transmission modes 1-8, and thus, may be scheduled partially on the segment carrier. The same situation may apply with a mobile terminal in transmission mode 9 with PMI/rank indicator (RI) disabled.

In some of the transmission modes, specifically, transmission modes 1-8, a mobile terminal would measure and report the CSI based on the CRS signals in the backward compatible carrier, and then, rely on CSI-RS signals in the segment carrier portion. Thus, a mobile terminal being configured in any of transmission modes 1-8 is undesirable for CSI measurement and reporting as it complicates implementation and makes testing requirements hard to define. Further, if a mobile terminal is configured in transmission mode 9, the specification does not support scheduling the mobile terminal if PMI or the RI is disabled in the segment carrier.

Another issue involves the aggregation of the extra bandwidth with the inclusion of the segment carrier. With the extra bandwidth aggregated, the sub band size for narrow CQI or PMI reporting for non-legacy mobile terminals, mobile terminals that support the segment carrier feature, may differ from the legacy terminals. Thus, this variance in the sub band size may complicate scheduling at the base station, and also, complicate CSI measurement and reporting. Also, there may be a problem with CSI measurement and reporting if the base station schedules the mobile terminal in transmission modes 1-8, or in transmission mode #9 with PMI and RI disabled on the segment carrier.

### BRIEF SUMMARY

Therefore, methods, apparatus and computer program products are provided for determining when, and how, to obtain CSI information for the segment carrier. Methods, apparatus, and computer program products are also provided for determining when, and how, to obtain CSI information for an extension carrier. The methods, apparatus, and computer program products according to the various embodiments determine when CSI information should be measured, and also, ascertain when such CSI information should be reported to the base station. In certain situations, such as when the bandwidth of the segment carrier is small, CSI information may not be reported to the base station, as reporting CSI information in such cases may be inefficient, and in these cases, the base station relies on CSI information corresponding to the nearest sub band associated with the backwards compatible carrier. Some example embodiments also address the configurations of the reference signals on the segment carrier or extension carrier. The various embodiments provide such direction without providing unnecessary restrictions or complexity as far as configuration of the mobile terminal or base station, and thus, results in a much simpler and efficient design.

In one example, a method comprises: determining whether channel state information is needed for a channel of a segment carrier comprising a contiguous bandwidth extension of a backward compatible carrier utilized by a base station for wireless communications with a mobile terminal, or an extension carrier; and in response to determining that channel state information is needed, configuring the mobile terminal to communicate channel state information from the mobile terminal to the base station. The method may comprise determining includes ascertaining whether a bandwidth of the contiguous bandwidth extension is similar to a coherence bandwidth of the channel. In response to determining that channel state information is not needed, the method may comprise configuring the mobile terminal not to communicate channel state information from the mobile terminal to the base station.

The method may, when configuring the mobile terminal, cause the mobile terminal to communicate the channel state information separately from the backward compatible carrier in the case of a segment carrier, and cause the mobile terminal to communicate the channel state information jointly with at least one sub-band in the backward compatible carrier. In response to determining channel state information is needed, the method may comprise triggering measurement and communication of channel state information by the mobile terminal via a physical downlink control channel. In this example embodiment, configuring may include causing configuration data to be communicated to the mobile terminal corresponding to a transmission mode used by the mobile terminal in which a cell-specific reference signal is used by the mobile terminal to transmit channel state information.

In this example embodiment, configuring may also include causing configuration data to be communicated to the mobile terminal corresponding to a transmission mode used by the mobile terminal in which no pre-coding matrix indicator or rank indicator is transmitted by the mobile terminal, causing configuration data to be communicated to the mobile terminal corresponding to a transmission mode used by the mobile terminal in which a pre-coding matrix indicator or rank indicator is transmitted by the mobile terminal, or causing configuration data to be communicated to the mobile terminal identifying a sub-band of the segment carrier in which a cell-specific reference signal is present.

In another example embodiment, a method comprises: receiving at a mobile terminal configuration data indicating whether channel state information for a channel of an extension carrier or a segment carrier comprising a contiguous bandwidth extension of a backward compatible carrier utilized by a base station and the mobile terminal for wireless communications is to be measured by the mobile terminal and communicated to the base station; in response to the configuration data indicating that channel state information is to be measured by the mobile terminal, measuring channel state information for the channel; and in response to the configuration data indicating that channel state information is to be communicated to the base station, causing measured channel state information for the channel to be communicated to the base station.

In this example embodiment, the configuration data may further indicate that a channel state information reference signal is present on (or associated with) the segment carrier, and wherein measuring and communicating are based on the channel state information reference signal. The configuration data may further indicate that a cell-specific reference signal is present on (or associated with) the segment carrier, and wherein measuring and communicating are based on the cell-specific reference signal.

The method may comprise de-mapping and rate de-matching the segment carrier in response to decoding of a physical downlink shared channel being scheduled in a downlink sub frame. The de-mapping and rate de-matching may be based at least in part on whether a channel state information reference signal is present alone or in combination with a cell-specific reference signal, or may be based at least in part on whether a cell-specific reference signal is present alone or in combination with a channel state information reference signal.

This method may further comprise receiving comprises receiving instructions not measure and report the CSI corresponding to the segment carrier part if the mobile terminal is informed via higher layer that there is no CRS on the segment carrier part, and if the mobile terminal is in any of transmission modes #1-#8 on the associated backward compatible carrier. The receiving step may further comprise the mobile terminal receiving a notification from a base station via higher layer that CRS is not present on the segment carrier if the mobile terminal are in transmission mode #9 on the associated backward compatible carrier with PMI/RI disabled, wherein the CSI measurement and reporting for the segment part may be configured to be in an OFF state via higher layer signaling from the base station. In this example embodiment, if the mobile terminal is configured in transmission mode #9, the method may further comprise configuring the mobile terminal from a base station so that only CSI-RS is present on the segment part during a time period, and eNB is able to inform all the new UEs among the different possibilities, e.g., CRS not present on the segment carrier, only CSI-RS present on the segment carrier, only CRS present on the segment carrier, or both CRS and CSI-RS are present on the segment carrier, via higher layer signaling.

In an example embodiment, an apparatus comprises: at least one processor; and at least one memory including computer program code, the at least one memory and the computer program code configured to, with the at least one processor, cause the apparatus at least to: determine whether channel state information is needed for a channel of an extension carrier or a segment carrier comprising a contiguous bandwidth extension of a backward compatible carrier utilized by a base station for wireless communications with a mobile terminal; and in response to determining channel state information is needed, configure the mobile terminal to communicate channel state information from the mobile terminal to the base station. In this example embodiment, the at least one memory and the computer program code are further configured to, with the at least one processor, cause the apparatus to ascertain whether a bandwidth of the contiguous bandwidth extension is similar to a coherence bandwidth of the channel, and configure the mobile terminal not to communicate channel state information from the mobile terminal to the base station in response to determining no channel state information is needed.

The at least one memory and the computer program code may be configured to, with the at least one processor, cause the apparatus to cause the mobile terminal to communicate the channel state information separately from the backward compatible carrier, to cause the apparatus to cause the mobile terminal to communicate the channel state information jointly with at least one sub-band in the backward compatible carrier, and to cause the apparatus to trigger measurement and communication of channel state information by the mobile terminal via a physical downlink control channel in response to determining channel state information is needed. The at least one memory and the computer program code may be further configured to, with the at least one processor, cause the apparatus to cause configuration data to be communicated to the mobile terminal corresponding to a transmission mode used by the mobile terminal in which a cell-specific reference signal is used by the mobile terminal to transmit channel state information, to cause configuration data to be communicated to the mobile terminal corresponding to a transmission mode used by the mobile terminal in which no pre-coding matrix indicator or rank indicator is transmitted by the mobile terminal, and to cause configuration data to be communicated to the mobile terminal corresponding to a transmission mode used by the mobile terminal in which a pre-coding matrix indicator or rank indicator is transmitted by the mobile terminal.

In this example embodiment, the at least one memory and the computer program code may be configured to, with the at least one processor, cause the apparatus to cause configuration data to be communicated to the mobile terminal identifying a sub-band of the segment carrier in which a cell-specific reference signal is present. In this and other example embodiments, the apparatus may comprise a mobile terminal or a base station, without limitation.

In another example embodiment, an apparatus comprises means for determining whether channel state information is needed for a channel of an extension carrier or a segment carrier comprising a contiguous bandwidth extension of a backward compatible carrier utilized by a base station for wireless communications with a mobile terminal; and means for configuring the mobile terminal to communicate channel state information from the mobile terminal to the base station in response to determining channel state information is needed.

In yet another example embodiment, an apparatus comprises means for receiving at a mobile terminal configuration data indicating whether channel state information for a channel of an extension carrier or a segment carrier comprising a contiguous bandwidth extension of a backward compatible carrier utilized by a base station and the mobile terminal for wireless communications is to be measured by the mobile terminal and communicated to the base station; means for measuring channel state information for the channel in response to the configuration data indicating channel state information is to be measured by the mobile terminal; and means for causing measured channel state information for the channel to be communicated to the base station in response to the configuration data indicating channel state information is to be communicated to the base station.

In yet another example embodiment, an apparatus comprises at least one processor; and at least one memory including computer program code, wherein the at least one memory and the computer program code are configured to, with the at least one processor, cause the apparatus at least to perform: define or more resource elements of a physical resource block (PRB) to be allocated for provision of channel state information signals from a mobile terminal; define one or more second resource elements of the PRB to be allocated for provision of channel state information reference signals; wherein at least one resource element per PRB is associated with each port in the frequency domain. The apparatus according to this and other example embodiments may comprise, without limitation, a mobile terminal.

In some example embodiments, the backwards compatible carrier may comprise an extension carrier, which has a considerably large bandwidth and a different transmission mode than the backward compatible carrier. In these example embodiments, if CRS is present on a segment carrier, then the base station configures the mobile terminal with the types of reference signals that will be present on the extension carrier.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the invention in general terms, reference will now be made to the accompanying drawings, which are not necessarily drawn to scale, and wherein:

FIG. 1 illustrates a system including a mobile terminal and a base station configured to support communications in accordance with one embodiment of the present invention;

FIG. 2 is a block diagram of a mobile terminal in accordance with one embodiment of the present invention;

FIG. 3 is a block diagram of a base station or other network element in accordance with one embodiment of the present invention;

FIG. 4 is a flow chart illustrating the operations performed from the perspective of a base station in accordance with one embodiment of the present invention;

FIG. 5 is a flow diagram illustrating the operations performed from the perspective of a mobile terminal in accordance with one embodiment of the present invention.

FIG. 6 is a flow diagram illustrating the operations performed from the perspective of a mobile terminal in accordance with one embodiment of the present invention.

FIG. 7 is a reference signal diagram illustrating the CRS pattern in a PRB according to one example embodiment of the present invention.

FIG. 8 is a flow diagram illustrating the operations performed from the perspective of a mobile terminal in accordance with one example embodiment of the present invention when the CSI measurement and reporting is in an ON state.

FIG. 9 is a flow diagram illustrating the operations performed from the perspective of a mobile terminal regarding PDSCH demapping and rate de-matching in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

As used in this application, a mobile terminal or device may include but is not limited to the following: (a) wired and wireless telephones (b) satellite telephones (c) personal communication devices; (d) electronic devices configured to share content in a local area network (LAN); (e) electronic gaming devices including, but not limited to, Nintendo® Gameboy® devices; (f) electronic music devices including, but not limited to, Apple® iPod® devices; (g) telecommunications network infrastructure equipment, including but not limited to a base station; (h) dual-mode cellular terminals which utilizes a cellular network and a non-cellular network; (i) any type of mobile terminal in a telecommunications network; (j) any machines configured for wireless communications in various applications, including but not limited to, an automobile with wireless communication capabilities, smart homes, smart metering, fleet management, remote healthcare, or access network operation management; or (k) any network entity, network component, or other network member. Further, in this application, any reference to a segment carrier also includes an extension carrier as the various embodiments of this invention may also apply to an extension carrier.

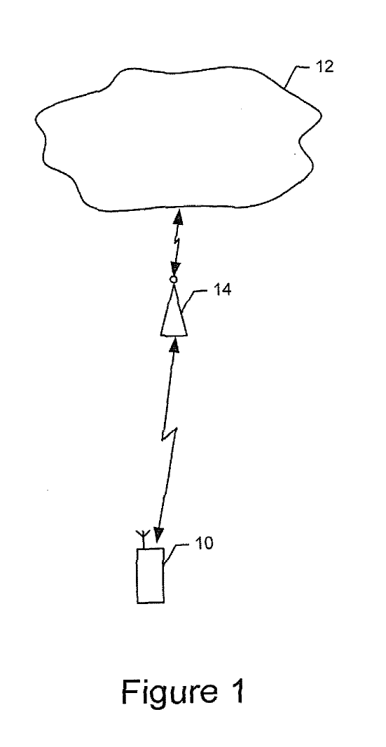

A method, apparatus and computer program product are disclosed for defining a plurality of resource elements for the provision of channel state information reference signals in an extension carrier or a segment carrier having a backward compatible portion. Although the method, apparatus and computer program product may be implemented in a variety of different systems, one example of such a system is shown in FIG. 1, which includes a first communication device (e.g., mobile terminal 10) that is capable of communication with a network 12 (e.g., a core network) via a transmit point 14 (e.g., an evolved Node B (eNB) or an array of antennas connected to an eNB). While the network may be configured in accordance with LTE or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 12 may include a collection of various different nodes, devices or functions that may be in communication with each other via corresponding wired and/or wireless interfaces. For example, the network may include one or more transmit points 14, each of which may serve a coverage area divided into one or more cells. The transmit points or other communication node could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

A communication device, such as the mobile terminal 10 (also known as user equipment (UE)), may be in communication with other communication devices or other devices via the transmit point 14 and, in turn, the network 12. In some cases, the communication device may include an antenna for transmitting signals to and for receiving signals from a transmit point. In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 12.

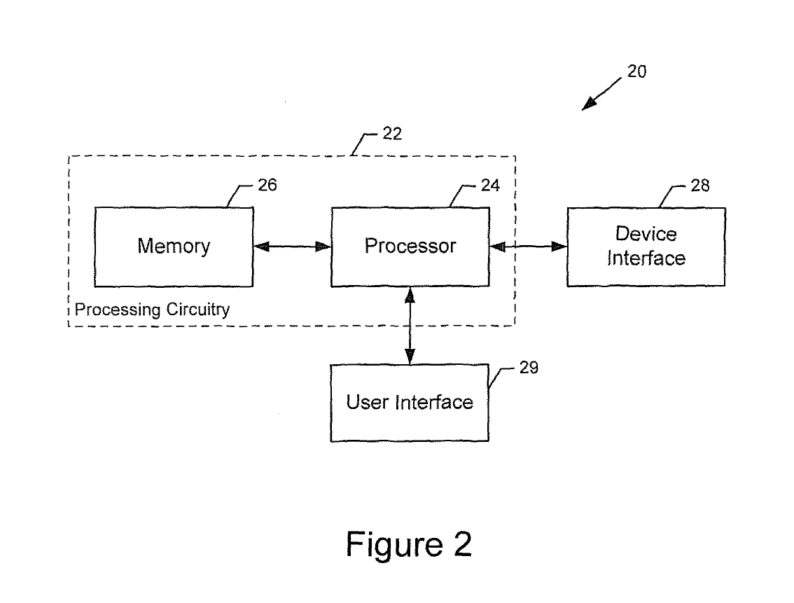

In one embodiment, for example, the mobile terminal 10 may be embodied as or otherwise include an apparatus 20 as generically represented by the block diagram of FIG. 2. In the context of a mobile terminal, the apparatus may be configured to define a plurality of resource elements for the provision of channel state information reference signals. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 22. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

As noted above, a transmit point 14 or other network entity may be configured to communicate with the mobile terminal 10. In some cases, the transmit point may include an antenna or an array of antennas for transmitting signals to and for receiving signals from the mobile terminal. The transmit point may be embodied as a base station or may be communicably connected to a base station with the base station including one or more processors that may define processing circuitry either alone or in combination with one or more memories. The processing circuitry may utilize instructions stored in the memory to cause the base station to operate in a particular way or execute specific functionality when the instructions are executed by the one or more processors. The transmit point may also include communication circuitry and corresponding hardware/software to enable communication with the mobile terminal and/or the network 12.

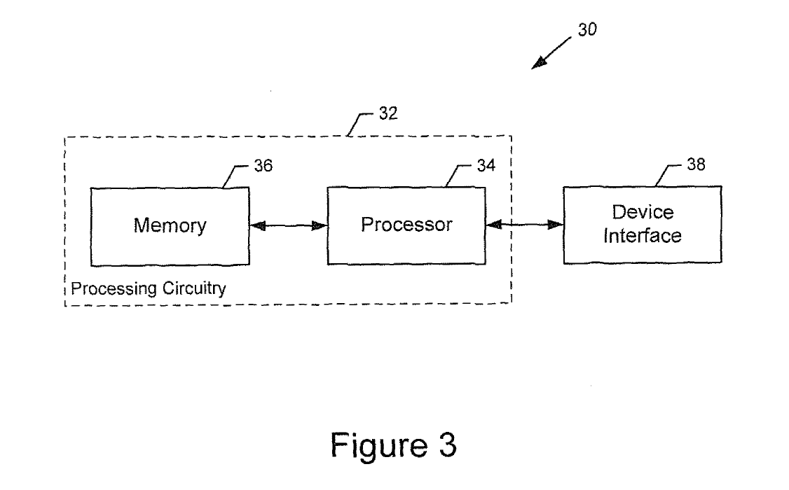

In one embodiment in which the transmit point 14 is in communication with a base station, such as an eNB, an access point or the like, the base station may be embodied as or otherwise include an apparatus 30 as generically represented by the block diagram of FIG. 3. While the apparatus may be employed, for example, by a base station, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38. As such, the processing circuitry may be embodied as a circuit chip (e.g., an integrated circuit chip) configured (e.g., with hardware, software or a combination of hardware and software) to perform operations described herein. However, in some embodiments taken in the context of the base station, the processing circuitry may be embodied as a portion of a base station or other network entity.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 34 may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

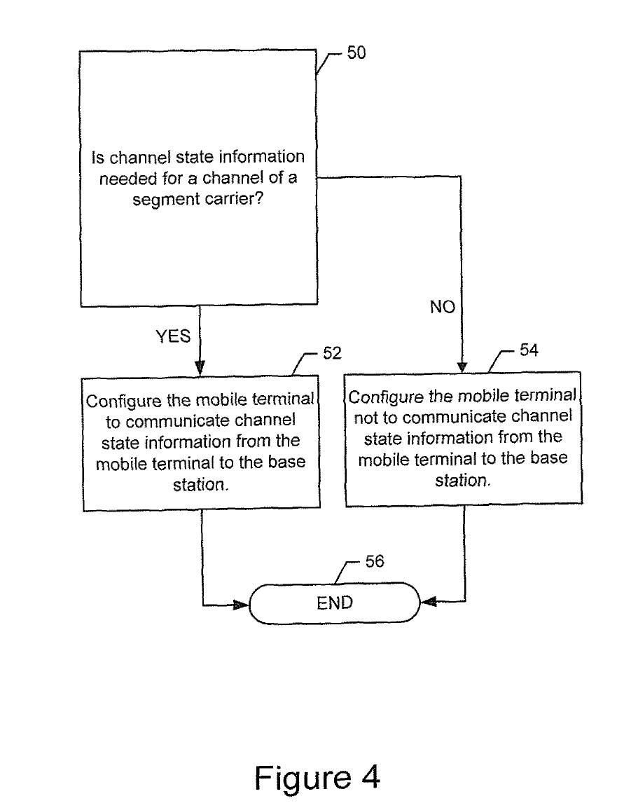

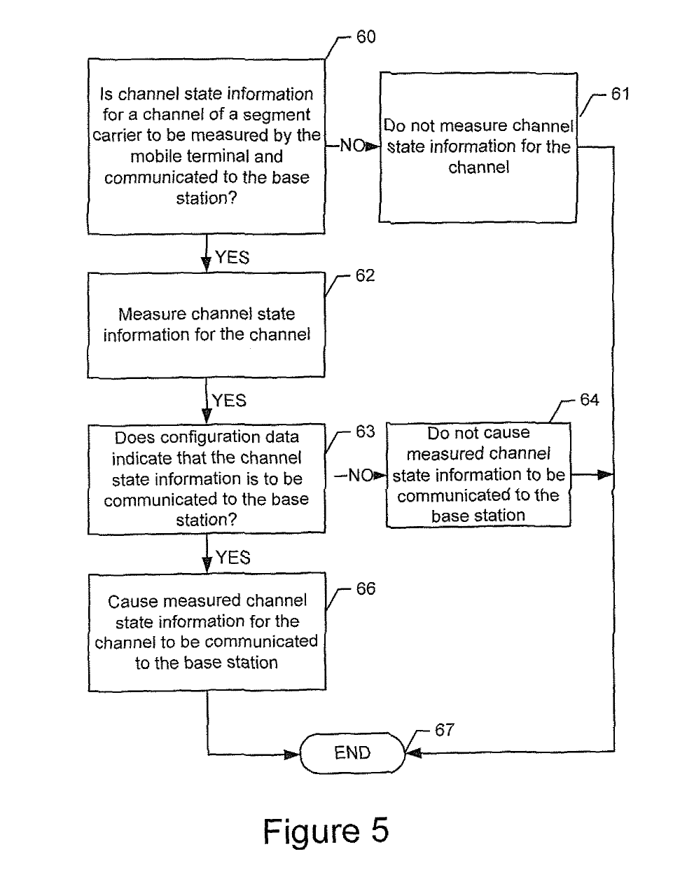

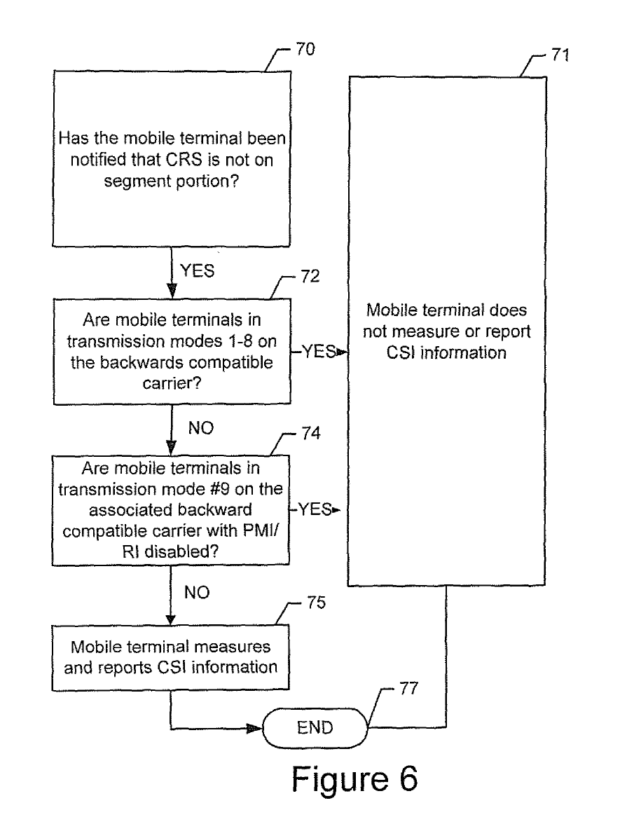

Referring now to FIGS. 4-6 and FIGS. 8 and 9, flowcharts illustrating the operations performed by a method, apparatus and computer program product, such as apparatus 20 of FIG. 2 in regards to the flowcharts of FIGS. 5, 8 and 9 and apparatus 30 of FIG. 3 in regards to the flowcharts of FIGS. 4 and 6, in accordance with example embodiments of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be defined by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 4-6 and FIGS. 8 and 9, when executed, convert a computer or processing circuitry into a particular machine configured to perform an example embodiment of the present invention. Accordingly, the operations of each of FIGS. 4-6 and FIGS. 8 and 9 define an algorithm for configuring a computer or processing circuitry, e.g., processor 24 in regards to the flowcharts of FIGS. 5, 8 and 9 and processor 34 in regards to the flowcharts of FIGS. 4 and 6, to perform an example embodiment. In some cases, a general purpose computer may be provided with an instance of the processor which performs the algorithm of a respective one of FIGS. 4-6 and FIGS. 8 and 9 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In various example embodiments of the present invention, an apparatus, such as a base station 14, may determine whether CSI information is needed for a channel of a segment carrier. FIG. 4 is a flow chart illustrating the operations performed from the perspective of an apparatus 30 embodied, for example, by a base station in accordance with one embodiment of the present invention. In these example embodiments, the apparatus 30 may include means, such as the processing circuitry 32, the processor 34 or the like, for determining if channel state information is needed for a segment carrier by ascertaining whether a bandwidth of the contiguous bandwidth extension is similar to a coherence bandwidth of the channel. See block 50. The similarity between the bandwidth of the contiguous bandwidth extension and the coherence bandwidth of the channel may be determined in various manners. In one embodiment, however, the apparatus 30, such as the processor 34, may determine whether the bandwidth of the contiguous bandwidth extension and the coherence bandwidth of the channel are similar by comparing the bandwidth of the segment carrier to a predefined threshold level. For example, in an instance in which the bandwidth of a segment carrier is below a predefined threshold level (such as, without limitation 6 physical resource blocks), the apparatus 30, such as the processor 34 may determine that the bandwidth of the contiguous bandwidth extension is dissimilar or at least not sufficiently similar to the coherence bandwidth of the channel such that treatment of the segment carrier as a sub band is not efficient. In such a situation, the apparatus may determine not to report CSI corresponding to the segment carrier and instead rely on CSI information relating to the nearest sub band on the backward compatible carrier.

If the apparatus 30 determines that channel state information is needed for the segment portion of a segment carrier, which as discussed in block 50 may involve determining that the bandwidth of the segment carrier is above a certain threshold bandwidth, the apparatus 30 may include means, such as the processing circuitry 32, the processor 34 or the like, for configuring the mobile terminal 10 to communicate channel state information from the mobile terminal to the base station, which may comprise configuring the mobile terminal to be in an ON or activated state (hereinafter generally referenced as an ON state) for CSI measurement and reporting. See block 52. The mobile terminal may also be configured to be in an ON state in response to determining that the base station is going to schedule PDSCH dynamically on the segment. Configuration of the mobile terminal in an ON state may be performed by the base station via higher layer signaling (such as, without limitation, mobile terminal specific radio resource control (RRC) signaling).

The apparatus 30 may also include means, such as the processing circuitry 32, the processor 34, the device interface 38 or the like, for configuring the mobile terminal, if the apparatus determines that channel state information is not needed for a segment carrier, for example if the bandwidth of a segment carrier is below a certain threshold level, to communicate channel state information from the mobile terminal 10 to the base station 14. See block 54. In this regard, the apparatus 30, such as the processor 34, may configure the mobile terminal 10 to be in an OFF or inactive state (hereinafter generally referenced as an OFF state) for CSI measurement and reporting. In one example embodiment of the present invention, the base station 14 may still transmit CRS on a segment carrier when the mobile terminal is in an OFF state, as CRS may be necessary for channel estimations in PDSCH detection in transmission modes 1-8. The transmission mode may be determined semi-statically based on several aspects such as the channel status, antenna configuration, and geometry. Further configuration of the mobile terminal 10 in an OFF state may be performed by the base station 14 via higher layer signaling (such as, without limitation, mobile terminal specific RRC signaling).

As shown in FIG. 5, an apparatus 20 embodied, for example by a mobile terminal 10 may include means, such as the processing circuitry 22, the processor 24 or the like, for determining if channel state information for a channel of a segment carrier is to be measured by the mobile terminal and communicated to the base station. See block 60. This determination may be based on configuration data sent to the mobile terminal 10 from the base station 14. This configuration data may indicate, without limitation, that a channel state information reference signal is present on (or associated with) the segment carrier, with measurement and communication of the CSI being based on the channel state information reference signal. Furthermore, this configuration data may be transmitted to the apparatus 20 via any communication protocol, including without limitation, a higher layer signaling protocol between a base station 12 and the mobile terminal 10.

In addition, if the configuration data indicates that CSI is to be measured by the apparatus 20, the configuration data may include additional instructions regarding how the apparatus should report the CSI information once it is obtained. For example, the configuration data could indicate that the apparatus 20 should communicate the CSI information for the segment portion separately from the backwards compatible portion of the segment carrier. Alternatively, the configuration data may indicate that the CSI for the segment portion should be reported jointly over one or more frequency sub bands in the backward compatible carrier.

The apparatus 20 may include means, such as the processing circuitry 22, the processor 24 or the like, for not measuring the CSI for the channel of the segment carrier if the configuration data indicates that CSI is not to be measured. See block 61. The apparatus 20 may also be configured, in response to receiving the configuration data which indicates that CSI is not to be measured, to be in an OFF state by another apparatus 30 such as a base station 14. The apparatus 20 may also, in response to being in an OFF state, assume the LTE Rel-10 definition of aperiodic CSI triggering, such as, by not triggering CSI measurement for the segment carrier.

In one example embodiment, the mobile terminal 10 may be configured with certain CSI reporting associated with the backward compatible carrier based on the transmission mode even when it is in an OFF state. In this example embodiment, the mobile terminal shall follow the CSI measurement and reporting specifications based on the bandwidth of the backwards compatible carrier.

The apparatus 20 may also include means, such as the processing circuitry 22, the processor or the like, for measuring the CSI for the channel of the segment carrier if the configuration data indicates that CSI is to be measured. See block 62. In order the measure the CSI for the channel of the segment carrier, the apparatus 20 may be changed to an ON state regarding CSI measurement and reporting. Each mobile terminal's CSI measurement and reporting for the segment part is triggered via PDCCH, and there may be a mobile terminal specific higher layer signaling to configure the redefinition needed to Release 10 aperiodic CSI triggering.

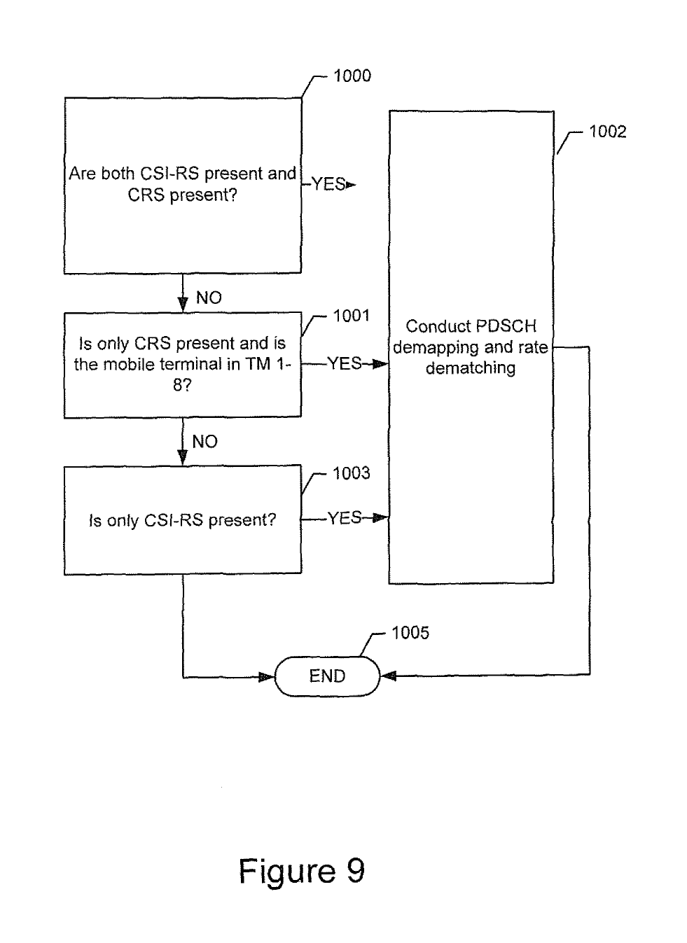

If the mobile terminal 10 is configured to be in an ON state, and the following two conditions are present: 1) the mobile terminal is in transmission mode 9, and 2) the mobile terminal is informed via higher layer signaling that CSI-RS is associated with the segment carrier, then the mobile terminal of one embodiment may perform the CSI measurement based on CSI-RS present or associated with the segment carrier. Alternatively, if the mobile terminal 10 is configured in transmission modes 1-8 and the mobile terminal is informed via higher layer signaling that CRS is present or associated with the segment carrier, then the mobile terminal may perform the CSI measurement based on the CRS present or associated with the segment carrier. The mobile terminal may also decode PDSCH if it is scheduled in the downlink sub frame. This process is discussed in the description of FIG. 9.

The apparatus 20 may also include means, such as the processing circuitry 22, the processor 24 or the like, for then determining if the configuration data indicates that the channel state information is to be communicated to the base station 10. See block 63. If not, the apparatus 20 of this embodiment includes means, such as the processing circuitry 22, the processor 24, the device interface 28 or the like, for not communicating the CSI to the base station 14 prior to terminating the process. See blocks 64 and 67, respectively. However, the apparatus 20 may include means, such as the processing circuitry 22, the processor 24, the device interface 28 or the like, for communicating the CSI to the base station 14 if the configuration data indicates that the CSI is to be communicated to the base station. See block 66.

This CSI information may be reported jointly with the adjacent sub band in the backward compatible carrier, independently reported, or reported to the mobile terminal 10 by the eNB 14. Three signals may be used to report this CSI information, and these three signals may be jointly encoded. Some examples of these encodings include, without limitation: the following: 1) For transmission modes 1-6, CRS is needed for the purpose of data demodulation and CSI reporting is based on the CRS with there being 6 states, that may be represented by 3 bits, as follows: (a) No CSI reporting with CSI-RS present; (b) no CSI reporting with CSI RS absent; (c) joint CSI reporting with CSI-RS present; (d) joint CSI reporting with CSI-RS absent; (e) separate CSI reporting with CSI-RS present; and (f) separate CSI reporting with CSI-RS absent; 2) Transmission modes 7, 8 and 9 without PMI/RI reporting, wherein demodulation can rely on DM-RS and CSI reporting is based on the CRS with there being 8 states, that may be represented by 3 bits, as follows: (a) No CRS and CSI-RS, therefore no CSI reporting; (b) no CRS but CSI-RS, no CSI reporting; (c) no CSI reporting with CRS and CSI-RS present; (d) no CSI reporting with CRS present and CSI-RS absent; (e) joint CSI reporting with CRS and CSI-RS present; (f) joint CSI reporting with CRS present and CSI-RS absent; (g) separate CSI reporting with CRS and CSI-RS present; and (h) separate CSI reporting with CRS present and CSI-RS absent; and 3) Transmission mode 9 with PMI.RI reporting, wherein demodulation relies on DM-RS and CSI measurement is based on CSI-RS with there being 8 states, that may be represented by 3 bits, as follows: (a) No CSI-RS and CRS, therefore no CSI reporting; (b) no CSI-RS but CRS, no CSI reporting; (c) no CSI reporting with CSI-RS and CRS present; (d) no CSI reporting with CSI-RS present and CRS absent; (e) joint CSI reporting with CSI-RS and CRS present; (f) joint CSI reporting with CSI-RS present and CRS absent; (g) separate CSI reporting with CSI-RS and CRS present; and (h) separate CSI reporting with CSI-RS present and CRS absent.

If all of the mobile terminals are in transmission mode #9, the base station 10 or other apparatus 20 embodied thereby may proceed as shown in FIG. 6. With all mobile terminals 10 in transmission mode #9, the base station 14 may be configured so that only CSI-RS is present or associated with the segment portion (and therefore, no CRS signals are associated with the segment portion). Then, the base station 14 may inform any new terminals of the configuration wherein only CSI-RS, but no CRS, signals are present via higher layer signaling. If CRS is present on an extension carrier, then the base station 14 can include in the configuration data an indication that only CRS is present in a sub band of the extension carrier. As such, the base station 14 may also identify which sub band among all sub bands is present. Thus, whether a mobile terminal 10 will measure and report CSI for the segment portion may be implicitly indicated by the semi-static configuration of certain reference signals associated with the segment portion or the ON/OFF CSI measurement and reporting configuration data received from the base station via higher level signaling.

FIG. 6 illustrates the process involved when an apparatus 30, such as a mobile terminal, determines whether to request a mobile terminal 10 to measure and report CSI information. In another example embodiment, the apparatus 30 performing the process in FIG. 6 may comprise a base station 14. An apparatus 30 of this embodiment may include means, such as the processing circuitry 32, the processor 34 or the like, for first determining whether the mobile terminal 10 has been notified that CRS is associated with the segment portion. See block 70. If the answer is no in response to block 70, then the apparatus 30 does not measure or report CSI information and the process terminates. See blocks 71 and 77 respectively. If the answer to block 70 is yes, then the apparatus 30 may include means, such as the processing circuitry 32, the processor 34 or the like, for determining if the mobile terminals 10 associated with the backwards compatible carrier are in transmission modes 1-8. See block 72. If the answer to block 72 is yes, then the mobile terminal 10 does not measure or report CSI information and the process terminates. See blocks 71 and 77 respectively.

The apparatus 30 may also include means, such as the processing circuitry 32, the processor 34 or the like, for determining, in an instance in which the mobile terminals are not in transmission modes 1-8, if the mobile terminals 10 in transmission mode #9 are associated with associated backward compatible carrier with PMI/RI disabled. See block 74. If the answer to block 74 is yes, then the mobile terminal 10 does not measure or report CSI information and the process terminates. See blocks 71 and 77 respectively. However, if the answer to block 74 is no, then the apparatus 30 include means, such as the processing circuitry 32, the processor 34 or the like, for proceeding to measure and report CSI information before terminating the procedure. See blocks 75 and 77 respectively.

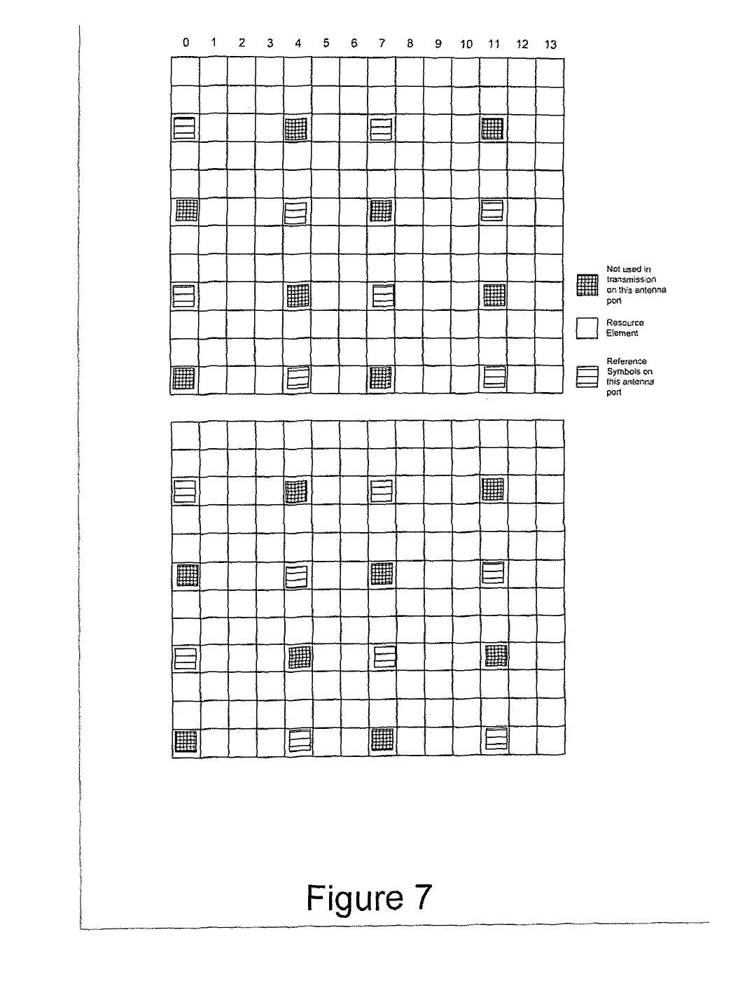

FIG. 7 is a reference signal diagram illustrating the CRS pattern in a PRB according to one example embodiment of the present invention which results in a significant reduction in signal overhead. As shown in FIG. 7, CRS is present in every downlink sub frame. The CSI-RS density is defined as one resource element per PRB per port in the frequency domain, and a duty cycle of x ms in the time domain, where x is configurable within the set of {5, 10, . . . } ms. When x=10 ms the overhead of CRS compared with CSI-RS (8 CSI-RS ports for example) is then 16/(8/10), i.e., 20 times. Thus, if in certain time period, the eNB 14 is configured such that only CSI-RS is present in the segment carrier, the reference signal overhead can be significant reduced in that time period.

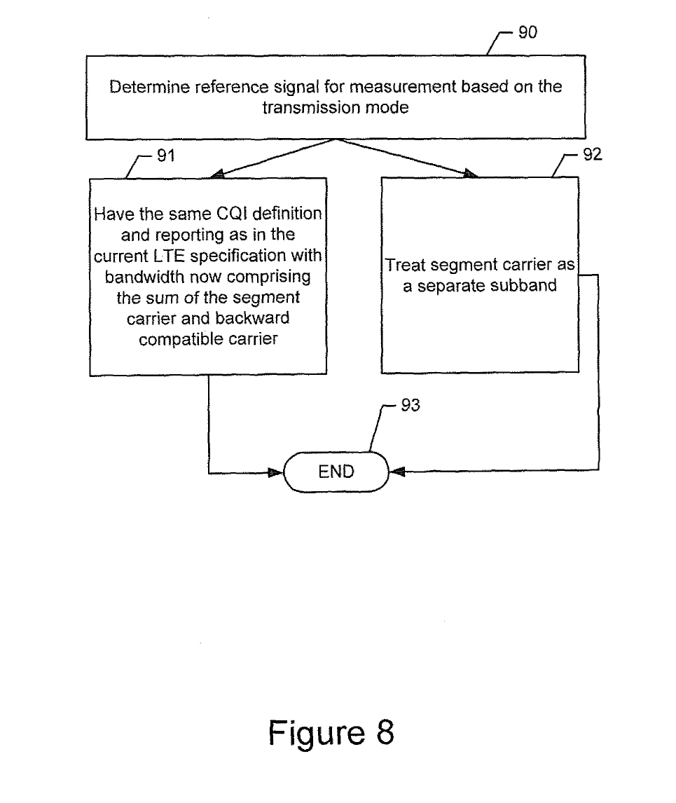

When a mobile terminal's CSI measurement and reporting is in an ON state, the apparatus 20 embodied, for example, by a mobile terminal 10 may perform the process as shown in FIG. 8. When the apparatus is in on “ON” state, the apparatus 20 may include means, such as the processing circuitry 22, the processor 24, the device interface 28 or the like, for first determining the reference signal for the CSI measurement based at least in part on the transmission mode (TM). See block 90. Considering the motivation of extension carriers (e.g., heterogeneous network (HetNet) intercell interference coordination (ICIC)), one possible use case is to allow only TM #9 since it is likely that the new mobile terminals 10 would support such transmission mode. In this case, the need of having any CRS is only for the purposes of time/frequency tracking, e.g., when the extension carriers would be in a different band than the backward compatible carrier. Thus, the reference signal overhead can be reduced to just have CRS in some sub frame(s) and/or some part of the frequency band, e.g. the center 6 PRBs. This would allow reuse of mobile terminal implementations. The exact sub frame or sub band associated with extension carrier in which the CRS will be present can be configured by base station 14 and indicated to the relevant mobile terminals 10. Furthermore, these configurations (or part of the band) can be coordinated among base stations 14 to allow possible interference coordination among them. The above implementation may be efficient especially when the following conditions are fulfilled: i) the extension carrier operates on a different band from backward compatible component carrier, so that time/frequency tracking requires CRS associated with extension carrier, and ii) TM #9 is always considered more efficient than the other transmission modes, depending on, for example, mobile terminal speed, antenna number and also reference signal (RS) density.

The apparatus 30 may then proceed according to at least one of two options. The apparatus 30, such as the processor 34, may have the same CQI definition and reporting as in the current LTE specification with the bandwidth now comprising the sum of the segment carrier and backward compatible carrier. See block 91. Alternatively, the apparatus 30, such as the processor 34, may also treat the segment carrier as a separate sub band in terms of narrow band CQI or narrow band PMI measurement or reporting. See block 92. In this case, the bandwidth of the segment carrier may be, but is not required to be, equal to the sub band size defined in Releases 8-10 of the LTE specification for a backwards compatible carrier. In the backward compatible carrier, all mobile terminals (regardless of the ability of the mobile terminal to support the segment carrier or not) may report the CQI or PMI based on the same definition of the sub band. A benefit of this approach may be that reporting the CQI and PMI based on the same definition of the sub band may facilitate multiple user scheduling at the eNB side. The apparatus of this embodiment terminates the process at block 93.

The methods, apparatus, and computer program products of the various embodiments of the present invention provide many advantages. For example, the base station may determine when CSI measurement and reporting is required based on the practical scenario. Also, mobile terminals operating in transmission modes #1-8 may be scheduled on or at least partially associated with the segment carrier according to the various embodiments of the present invention as both CSI-RS and CRS can be present. Furthermore, the methods, apparatus, and computer program products are easy to implement, and thus, more efficient. Also, the methods, apparatus, and computer program products may result in a reduction of reference signal overhead associated with the segment carrier.

Additional advantages of the various example embodiments of the invention include that the base station 14 is able to decide whether CSI measurement and reporting is done for the segment carrier based on the practical scenario. An example embodiment of the present invention may provide minimum impact to the implementation of the mobile terminal 10 in terms of measurement and reporting, as there is maximum reuse of Rel-8/9/10 behavior. There is also the possibility to reduce the reference signal overhead associated with the segment carrier or the extension carrier.

FIG. 9 is a flow diagram illustrating the operations performed from the perspective of a mobile terminal 10 regarding PDSCH demapping and rate de-matching in accordance with one embodiment of the present invention. This process occurs when the mobile terminal 10 is configured in an ON state for CSI measurement and reporting. Once in an ON state, if the mobile terminal 10 is scheduled in the downlink sub frame, the mobile terminal 10 may include means, such as the processing circuitry 22, the processor 24 or the like, for performing PDSCH demapping and rate dematching if CSI-RS and CRS are present. See blocks 1000 and 1002. If both CSI-RS and CRS are present, then mobile terminals 10 in the same transmission mode associated with the carrier segment and associated backward compatible carrier perform PDSCH demapping and rate de-matching.

If only CRS is present, then only mobile terminals 10 in transmission modes 1-8 associated with the carrier segment and associated backward compatible carrier perform PDSCH demapping and rate de-matching. See blocks 1001 and 1002. Further, if only CSI-RS is present, then the mobile terminal 10 performs PDSCH demapping and rate de-matching. See blocks 1003 and 1002. The process terminates at 1005.

Regarding implementation of PDSCH demapping and rate de-matching on the mobile terminal, when the mobile terminal is configured in transmission modes #1-#8, the following should be noted: 1) For all mobile terminals that are configured in transmission modes #1-#8, the mobile terminals do not have to be aware of the presence of CSI-RS on a segment carrier, i.e., if CSI-RS is present, it will simply puncture into the PDSCH resources for the UEs. In this case, eNB only needs to inform via higher layer signaling to the UEs that are configured in transmission mode #9 whether there is CRS or not on the segment carrier during a given time period. 2) When the mobile terminal is configured in transmission mode #1-#8, the mobile terminal will take the CSI-RS into account in the PDSCH demapping and rate de-matching process if the mobile terminal has received, or can access, the configurations of CSI-RS signals on the backward compatible carrier and also on the segment carrier. The mobile terminal should conclude there is a misconfiguration, and thus unspecified mobile terminal behavior, if either of the following occur: 1) the mobile terminal is configured in transmission mode #1-#8, but CRS are not configured on the segment carrier, or 2) the mobile terminal is configured in transmission mode #9, but CSI-RS is not configured on the segment carrier.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
determining whether channel state information is needed for a channel of a segment carrier; and
in response to determining that channel state information is needed, configuring a mobile terminal to communicate channel state information from the mobile terminal to the base station.

2. The method of claim 1, wherein the segment carrier comprises a contiguous bandwidth extension of a backward compatible carrier, and the determining includes ascertaining whether a bandwidth of the contiguous bandwidth extension is similar to a coherence bandwidth of the channel.

3. The method of claim 1, further comprising, in response to determining that channel state information is not needed, configuring the mobile terminal not to communicate channel state information from the mobile terminal to the base station.

4. The method of claim 1, wherein the segment carrier comprises a contiguous bandwidth extension of a backward compatible carrier, and the configuring includes causing the mobile terminal to communicate the channel state information separately from the backward compatible carrier.

5. The method of claim 1, wherein the segment carrier comprises a contiguous bandwidth extension of a backward compatible carrier, and the configuring includes causing the mobile terminal to communicate the channel state information jointly with at least one sub-band in the backward compatible carrier.

6. The method of claim 1, further comprising, in response to determining that channel state information is needed, triggering measurement and communication of channel state information by the mobile terminal via a physical downlink control channel.

7. The method of claim 1, wherein configuring includes causing configuration data to be communicated to the mobile terminal corresponding to a transmission mode used by the mobile terminal in which a cell-specific reference signal is used by the mobile terminal to transmit channel state information.

8. The method of claim 1, wherein configuring includes causing configuration data to be communicated to the mobile terminal corresponding to a transmission mode used by the mobile terminal in which no pre-coding matrix indicator or rank indicator is transmitted by the mobile terminal.

9. The method of claim 1, wherein configuring includes causing configuration data to be communicated to the mobile terminal corresponding to a transmission mode used by the mobile terminal in which a pre-coding matrix indicator or rank indicator is transmitted by the mobile terminal.

10. The method of claim 1, wherein configuring includes causing configuration data to be communicated to the mobile terminal identifying a sub-band of the segment carrier in which a cell-specific reference signal is present.

11. The method of claim 1, wherein the segment carrier comprises a contiguous bandwidth extension of a backward compatible carrier or an extension carrier utilized by a base station for wireless communications with a mobile terminal.

12. (canceled)

13. A method comprising:
receiving at a mobile terminal configuration data indicating whether channel state information is needed for a channel of a segment carrier;
in response to the configuration data indicating that channel state information is to be measured by the mobile terminal, measuring channel state information for the channel; and
in response to the configuration data indicating that channel state information is to be communicated to the base station, causing measured channel state information for the channel to be communicated to the base station.

14. The method of claim 13, wherein the configuration data further indicates that a channel state information reference signal or a cell-specific reference signal is associated with the segment carrier, and wherein measuring and communicating are based on the indicated channel state information reference signal or cell-specific reference signal.

15. (canceled)

16. The method of claim 13, further comprising, in response to decoding of a physical downlink shared channel being scheduled in a downlink sub frame, de-mapping and rate de-matching the segment carrier.

17. The method of claim 16, wherein de-mapping and rate de-matching is based at least in part on whether a channel state information reference signal is present alone or in combination with a cell-specific reference signal.

18. The method of claim 16, wherein de-mapping and rate de-matching is based at least in part on whether a cell-specific reference signal is present alone or in combination with a channel state information reference signal.

19. The method of claim 13, wherein receiving comprises determining whether the mobile terminal shall measure and report the CSI for the segment carrier based at least in part on the semi-static configuration of certain type of reference signals on the segment carrier or based on an ON/OFF CSI measurement and reporting configuration via higher-layer signaling.

20. The method of claim 13, wherein receiving comprises receiving instructions to not measure and report the CSI corresponding to the segment carrier if the mobile terminal is informed via higher layer that there is no CRS on the segment carrier, and if the mobile terminal is in any of transmission modes #1-#8 on the associated backward compatible carrier.

21. (canceled)

22. The method of claim 13, wherein if the mobile terminal is configured in transmission mode #9, configuring the mobile terminal from a base station so that only CSI-RS is present on the segment carrier during a time period.

23. An apparatus comprising:
at least one processor; and
at least one memory including computer program code, the at least one memory and the computer program code configured to, with the at least one processor, cause the apparatus at least to:
determine whether channel state information is needed for a channel of a segment carrier; and
in response to determining channel state information is needed, configure the mobile terminal to communicate channel state information from the mobile terminal to the base station.

24-36. (canceled)
